(19) United States
(12) Patent Application Publication
(10) Pub. No.: US 2026/0220382 A1
(43) Pub. Date: Jul. 30, 2026

(54) ENTITY IDENTIFICATION AND ENTITY ATTRIBUTE VERIFICATION USING LARGE LANGUAGE MODELS

(71) Applicant: EQUIFAX INC., Atlanta, GA (US)

(72) Inventors: Sukanksha TOTADE, Dunwoody, GA (US); Dilip Kumar SINGH, Alpharetta, GA (US); Sukesh Kumar, Suwanee, GA (US)

(21) Appl. No.: 19/039,549

(22) Filed: Jan. 28, 2025

(51) Int. Cl. G06F 40/35; G06F 9/38; G06F 16/3329

(52) U.S. Cl. CPC G06F 40/35; G06F 9/3851; G06F 16/3329

(57) ABSTRACT

A system can identify entities and verify entity attributes by leveraging the ability of trained large language model (LLM) to extract entity information from data instances of one or more data sources. The data instances may be, for example, writings such as news articles. The writings may include information about entities and/or events in which the entities were involved. The system may generate a pair of input prompts for the LLM to cause the LLM to process a data instance(s). Each prompt may include a deliberately false data item and the LLM may be caused to generate a response for each prompt. The validity of the information in the responses can be verified by determining that false data items in both responses match. The system can configure another computing system to utilize information about a given entity identified in the data instance and included in the responses.

### TECHNICAL FIELD

The present disclosure relates generally to optimizing computing operations. More specifically, but not by way of limitation, the disclosure relates to the identification of entities and the verification of entity attributes based on event information extracted from data sources, and to configuring related computer systems accordingly.

### BACKGROUND

Various systems may use entity attributes (e.g., credit/risk scores, revenue, stability) to approve or deny certain interactions with the entity. The attributes of an entity can change, often without notice and without the knowledge of others who may desire to interact with the entity. For example, an entity of interest may merge with another entity, may acquire another entity, or may be acquired by another entity. There are millions of data sources (e.g., news articles and publications) that are accessible via the Internet and contain information about entities and events in which the entities are involved. To parse these data sources for use in entity identification and attribute verification, systems currently rely on manual examination of the data sources or of summaries of the data sources, leading to inefficiencies, inaccuracies, high costs, and limitations in scalability.

### SUMMARY

Various embodiments of the present disclosure provide computing systems and computer-implemented methods that employ large language models to identify entities, or verify entity attributes or entity statuses based, for example, on event information extracted from data sources. Information regarding the entities that is extracted from the data sources may be used to configure the operation of other computing systems. According to one example, a system can include a processor and a memory, such as a non-transitory computer-readable medium, which includes instructions that are executable by the processor to cause the processor to perform various operations. According to aspects of the present disclosure, the operations can include accessing a data instance of a data source, and providing a first prompt to a trained large language model, the first prompt including a query regarding possible entity information in the data instance, a false data item, and instructions that define a format for a response to the query and direct the trained large language model to return the false data item with the response. The operations can also include providing a second prompt to the trained large language model, the second prompt including the same query, the same false data item, and the same instructions as the first prompt. The operations can additionally include generating, using the trained large language model, a first response to the query of the first prompt and a second response to the query of the second prompt, and determining, by comparing the first response to the second response, that the false data item in the first response matches the false data item in the second response. The operations can further include based on the matching of the false data items, identifying one or both of the responses as a valid responses, and outputting a command to an entity monitoring computing system to configure an assessment function of the entity monitoring computing system to utilize information about a given entity identified in the data instance by the large language model and included in the responses.

According to an additional example, a computer-implemented method can include accessing, by a processor, a data instance of a data source, and providing, by the processor, a first prompt to a trained large language model, the first prompt including a query regarding possible entity information in the data instance, a false data item, and instructions that define a format for a response to the query and direct the trained large language model to return the false data item with the response. The computer-implemented method can also include providing, by the processor, a second prompt to the trained large language model, the second prompt including the same query, the same false data item, and the same instructions as the first prompt. The computer-implemented method can additionally include generating, using the trained large language model, a first response to the query of the first prompt and a second response to the query of the second prompt, and determining, by the processor, by comparing the first response to the second response, that the false data item in the first response matches the false data item in the second response. The computer-implemented method can further include based on the matching of the false data items, identifying one or both of the responses as a valid responses, and outputting, by the processor, a command to an entity monitoring computing system that configures an assessment function of the entity monitoring computing system to utilize information about a given entity identified in the data instance by the large language model and included in the responses.

According to another example, a non-transitory computer-readable storage medium may contain instructions that are executable by a processor to cause the processor to perform operations. According to aspects of the present disclosure, the operations can include accessing a data instance of a data source, and providing a first prompt to a trained large language model, the first prompt including a query regarding possible entity information in the data instance, a false data item, and instructions that define a format for a response to the query and direct the trained large language model to return the false data item with the response. The operations can also include providing a second prompt to the trained large language model, the second prompt including the same query, the same false data item, and the same instructions as the first prompt. The operations can additionally include generating, using the trained large language model, a first response to the query of the first prompt and a second response to the query of the second prompt, and determining, by comparing the first response to the second response, that the false data item in the first response matches the false data item in the second response. The operations can further include based on the matching of the false data items, identifying one or both of the responses as a valid responses, and outputting a command to an entity monitoring computing system to configure an assessment function of the entity monitoring computing system to utilize information about a given entity identified in the data instance by the large language model and included in the responses.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of an operating environment in which an entity identification and entity attribute verification computing system can be used to identify entities and verify entity attributes according to some aspects of the present disclosure.

FIG. 2 is a block diagram depicting the input to and output of a large language model used to identify entities and verify entity attributes from data instances of one or more data sources according to some aspects of the present disclosure.

FIG. 3 is a flow diagram illustrating the use of the entity identification and verification computing system of FIG. 1 to identify an entity and verify entity attributes from a data instance of a data source according to some aspects of the present disclosure.

FIG. 4 is a flow chart illustrating a method for identifying an entity and verifying entity attributes from a data instance of a data source according to some aspects of the present disclosure.

FIG. 5 is a block diagram depicting an example of a computing device, which can be used to implement the embodiments described herein according to some aspects of the present disclosure.

### DETAILED DESCRIPTION OF THE INVENTION

Certain aspects and examples of the present disclosure relate to identifying an entity and verifying entity attributes (e.g., entity information) based on information obtained from one or more data sources. An entity may be an organization, but it is also possible in some examples for an entity to be an individual. In some examples, a data source may be a repository (e.g., an archive) of writings such as news articles, editorials, exposés, or other publications from which information about an entity may be scraped. In other examples, a data source may be a repository of summaries of various pieces of writings prepared by a trusted source. In certain examples, a data source may also or instead contain non-textual information (e.g., images, videos). In some examples, the writings (and/or images, videos, etc.) may describe or otherwise evidence an event(s) that affects an entity, and the entity's involvement in the event can be used identify the entity, verify attributes of the entity, determine a hierarchy associated with the entity, etc.

Certain aspects described herein for identifying entities and verifying entity attributes using event or other information extracted from one or more data sources can address one or more issues. For example, in certain aspects, disclosed systems and methods can improve the scalability and automation of data source review by analyzing large numbers of documents (i.e., data sources), which is both fast and less error-prone than manual examination of data sources. Further, disclosed systems and methods integrate a validation function that ensures any information extracted by a large language model from one or more data sources is accurate and not the byproduct of a model hallucination.

In some examples, a computing system can access a data instance (e.g., a news article or another publication) of a data source. In some aspects, the data instances can be retrieved from one or more databases storing the data sources. In another aspect, data instances can be received in a summary form generated by trusted source as a result of, for example, a batched web scraping operation. The computing system can employ a trained large language model to extract entity information from each data source, or from each data summary, and the trained large language model can employ various natural language processing techniques to identify entities and verify entity attributes mentioned in the data source.

The computing system can also use the trained large language model to analyze extracted information to identify attributes associated with an entity in the extracted text. Examples of attributes can include entity names, acquisition dates, acquisition costs, acquiring party names, acquired party names, headquarters locations, or other useful characteristics such as number of employees, entity revenues, etc. By leveraging various prompt engineering techniques, some or all of such information may be requested to be included in responses of the trained large language model to queries on the data sources.

The computing system can cause the trained large language model to include a deliberately false data item in each response to a prompt. A pair of prompts including like queries, instructions, and false data items can thus be simultaneously input to the trained large language model to cause the trained large language model to generate a first response to the first prompt and a second response to the second prompt. One or both of the responses can thereafter be resolved to be valid (versus being the byproduct of a model hallucination) by comparing the first response to the second response and determining that the false data item in the first response matches the false data item in the second response.

In some examples, the computing system can output a command to another computing system, such as an entity monitoring computing system, to configure the computing system. For example, when the computing system to which the command is output is an entity monitoring computing system, an assessment function of the entity monitoring computing system may be configured by the command to utilize information about a given entity extracted by the large language model. In some examples, the entity monitoring computing system may be a credit reporting computing system, and the information may be used by the credit reporting computing system when calculating a credit/risk score or some other risk factor or characteristic associated with the entity.

In some examples, information about a given entity that is extracted from a data source(s) by the large language model and included in a response may be used by credential controlled computing system to control access to certain operations or areas of the credential controlled computing system, or to services offered by an owner or operator of the credential controlled computing system. For example, the information about a given entity can be used to calculate a financial risk score for the entity, and a credential controlled computing system may use the risk score to determine whether the entity can access certain areas (e.g., user interfaces) of the credential controlled computing system or whether the entity is eligible for certain products (e.g., loan products) offered by an owner or operator of the credential controlled computing system.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Identifying and Validating Entities From Data Sources

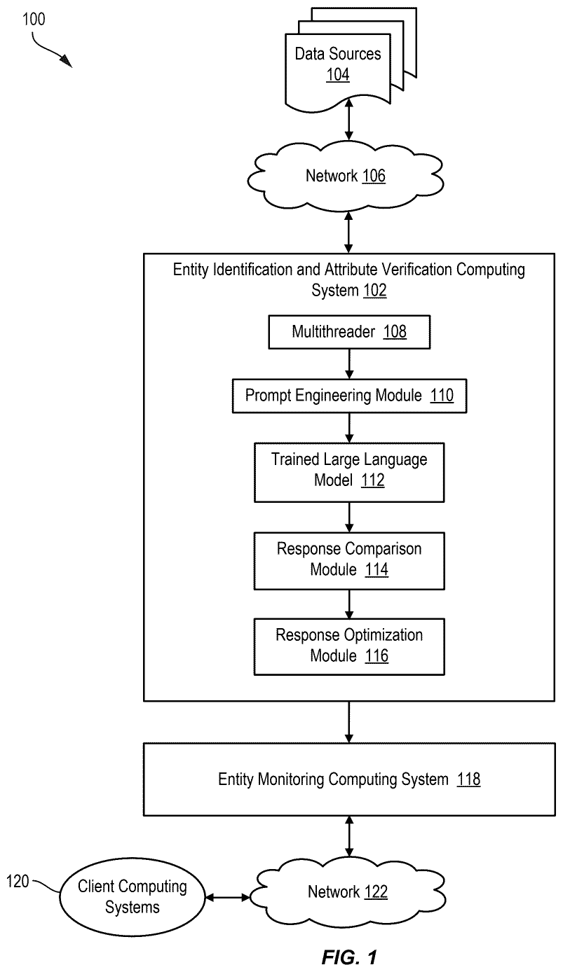

FIG. 1 is a block diagram depicting an example of an operating environment 100 in which an entity identification and attribute verification computing system (“computing system”) 102 can be used to identify an entity and verify entity attributes from a data source according to some aspects of the present disclosure. The computing system 102 can include one or more processing devices that can execute program code, such as code that causes one or more applications or modules to execute one or more operations associated with generating prompts, comparing LLM-generated responses to queries, etc. The program code can be stored on a non-transitory computer-readable medium or another suitable medium. The computing system 102 can be a specialized computing system that may be used for processing large amounts of data using a large number of computer processing cycles. In other examples, the computing system 102 may be or include a general-purpose computing system. In some examples, the computing system 102 can be a cloud computing system hosted by a cloud service provider using systems and infrastructure provided by the cloud service provider. Cloud services can provide the operator of the computing system 102 with scalable access to applications and computing resources without the need for the operator to invest in the infrastructure necessary to perform the functions of the computing system 102.

As shown, the computing system 102 can access one or more data sources 104 via a network 106. In some examples, a data source may be an external database or another repository (e.g., archive) of writings (i.e., data instances) such as news articles, editorials, exposés, or other publications from which information about an entity may be scraped. For example, an article about a merger or acquisition may include entity (e.g., a businesses or other organization) information such as the name of an acquiring entity, the name of an acquired entity, a monetary amount of the acquisition, the names of merging entities and the name of a resulting merged entity, entity demographics such as current or future business addresses, employee counts, yearly revenue, or other data. In the case of a writing discussing a merger, for example, hierarchical entity information may also be revealed—i.e., the name and/or other information about the surviving entity, parent company, successor, etc., after the merger. In other examples, a data source may be a repository of summaries of various writings prepared by a trusted source. For example, there are existing services that scrape such writings for entity information and provide the information in various forms (e.g., textual summaries, data tables).

The computing system 102 is shown to be communicatively coupled to the one or more data sources 104 via a network 106, such as a public data network, a private data network, or some combination thereof. A data network may include one or more of a variety of different types of networks including, for example, a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The computing system 102 may include one or more hardware components, software components, or combinations thereof. In this example, the computing system 102 includes at least a multithreader 108, a prompt engineering module 110, a trained large language model (LLM) 112, a response comparison module 114, and a response optimization module 116. Other components, or combinations of components is also possible.

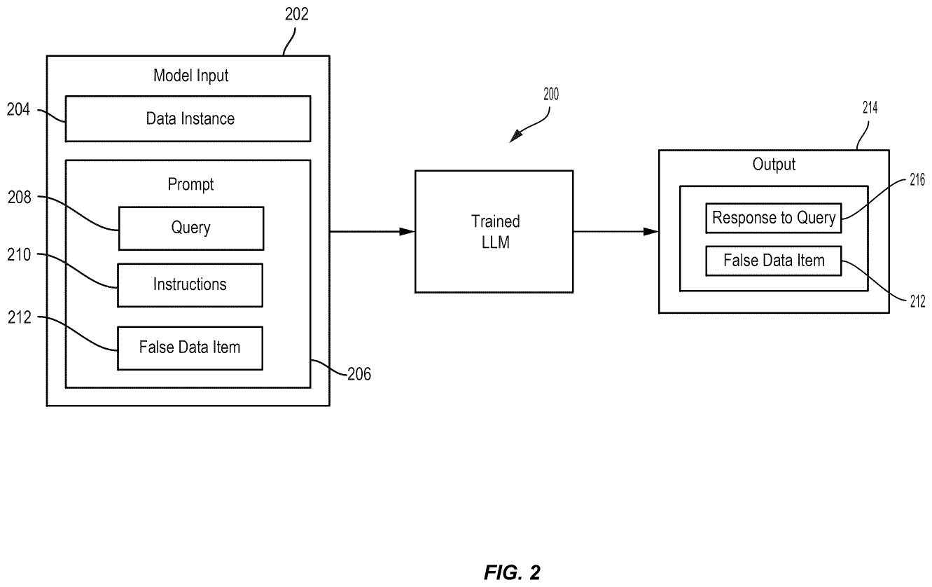

The multithreader 108 used in this example of the computing system 102 can allow the trained LLM 112 to process multiple threads of execution simultaneously. This can enable the LLM to perform tasks more efficiently and in parallel. In the context of identifying entities and verifying entity attributes using writings, multithreading can allow the trained LLM 112 to process different parts of a request (as dictated by a prompt) concurrently, rather than sequentially where a given part of the request must complete before processing of a next part can begin. For example, and as described in more detail relative to FIG. 2, multithreading can allow the trained LLM 112 to extract entity data from a data instance according to a query concurrently with processing a deliberately false data item. Additionally, by splitting the data and utilizing different threads to concurrently process different segments of the data, multithreading can allow the trained LLM 112 to parallel process multiple queries associated with different data instances. Further, and as also described in more detail relative to FIG. 2, multithreading can allow the trained LLM 112 to generate multiple outputs (responses) in parallel for different input prompts, which can reduce response time when processing large volumes of data and may optimize computational resources.

The prompt engineering module 110 can be implemented using software only, using hardware only, or using a combination of hardware and software. The prompt engineering module 110 can allow an operator of the computing system 102 to design and refine input prompts that are usable to guide the trained LLM 112 and to cause the trained LLM 112 to generate responses that are accurate and contextually appropriate. The prompt engineering module 110 can also be used to generate prompts that have a desired output length and include a desired level of detail. For example, if the prompt includes an instruction to summarize text, the instruction may limit the summary to a specific number of words.

A prompt generated using the prompt engineering module 110 can be a structured prompt, meaning that the prompt includes a query that is structured in a manner to prepare the trained LLM 112 to provide a specific type of answer to the query (e.g., the name of an acquiring entity). A prompt may also be an instruction based prompt that explicitly directs the trained LLM 112 to generate a more complex type of response. For example, a prompt generated using the prompt engineering module 110 may also include an instruction such as “if an acquisition occurred, store the name of the acquiring entity in column 1 of Table X.” In another example, a prompt generated using the prompt engineering module 110 may include an instruction such as “if the text of the data instance is not in English, provide a summary of the text in English.”

A prompt generated using the prompt engineering module 110 may also include contextual information that can set a desired tone for a response, and/or may include examples that can help the trained LLM 112 better understand the desired structure and format of the response. When responding to a query requires the trained LLM 112 to retrieve a data instance from a data source by querying a database, a prompt generated using the prompt engineering module 110 may also include a database schema and/or other database information necessary for the trained LLM 112 to successfully access the database and retrieve the correct information therefrom. In this regard, the trained LLM 112 may include natural language-to query language (e.g., NL2SQL) functionality.

In some examples, the prompt engineering module 110 may also be used to tune various parameters of the trained LLM 112. For example, the prompt engineering module 110 may be used in some examples to control the randomness of the responses generated by the trained LLM 112, such as by adjusting a temperature parameter of the trained LLM 112. In any case, the process of using the prompt engineering module 110 to generate prompts may be iterative in nature. That is, if a response generated by the trained LLM 112 based on a given prompt is not as expected or desired, the instructions associated with the prompt may be modified (e.g., by adding instructions or clarifying the existing instructions).

The specific nature of the trained LLM 112 can vary. For example, the trained LLM 112 may have a transformer-based architecture. As transformers can understand the relationships between words in a sentence, and most pre-trained LLM's have been trained on vast amounts of textual data, such as data from books, articles, papers, websites, and other written sources, transformer-based LLMs typically excel at tasks such as natural language processing (NLP). A pre-trained LLM can also be fine-tuned for specific tasks, such as text generation, text summarization, translation, question answering, and sentiment analysis.

In some examples, the trained LLM 112 may be a multimodal model. In addition to understanding textual inputs, a multimodal model can understand other types of data inputs, such as images, audio, and video, simultaneously. Thus, multimodal models can utilize information from different sources to generate more accurate and contextually appropriate responses. For example, when the trained LLM 112 is a multimodal model, the trained LLM 112 may analyze both a textual (and/or spoken) portion and an image associated with a data instance to better understand the information provided in the data instance and to generate an optimized response to an associated query. Examples of multimodal models that may be utilized as the trained LLM 112 include, for example and without limitation, GPT-4® from OpenAI® , Gemini™ from Google®, and CoPilot™ from Microsoft®.

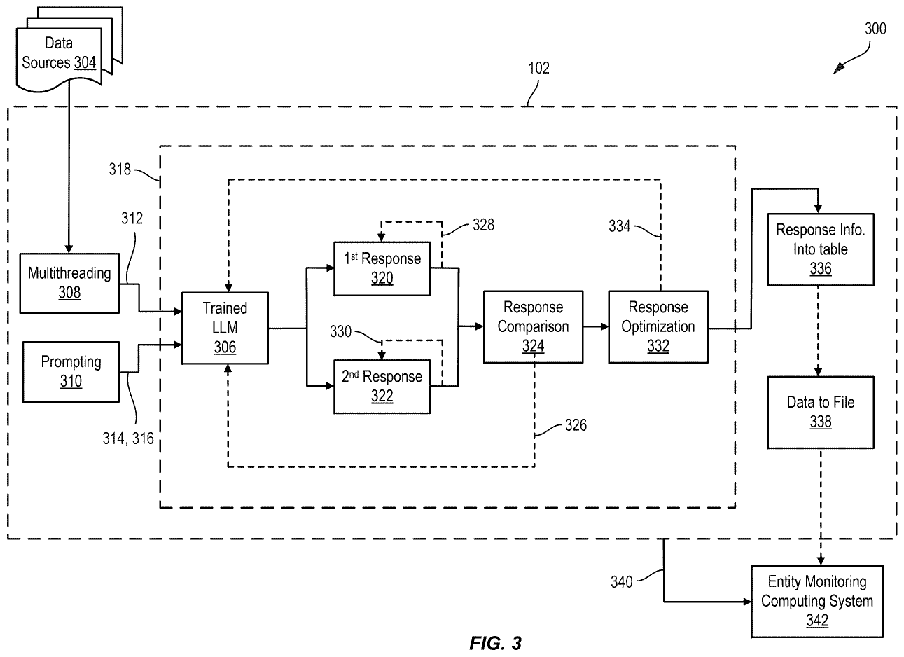

In the example of FIG. 1, the computing system 102 may also include a response comparison module 114. The response comparison module 114 can be implemented using software only, using hardware only, or using a combination of hardware and software. As described in more detail below with respect to FIG. 3, the response comparison module 114 may be used in a technique for ensuring that the trained LLM 112 does not generate an incorrect response due to hallucinations. In this regard, the response comparison module 114 can be used to compare the responses of the trained LLM 112 resulting from a pair of like prompts, each of which includes the same query, the same instructions, and the same deliberately false data item. More specifically, the response comparison module 114 can be used to determine if a response generated by the trained LLM 112 has been effected by hallucinations by comparing the false data items that are included in the responses to the prompts.

In the example of FIG. 1, the computing system 102 may further include a response optimization module 116. The response optimization module 116 can be implemented using software only, using hardware only, or using a combination of hardware and software. The response optimization module 116 can be used to analyze and, if necessary, optimize a valid response generated by the trained LLM 112. For example, if the information in a response generated by the trained LLM 112 is determined to be valid by the response comparison module 114, but the format of the information is different than a format specified in the instructions of the prompt that caused the response to be generated (e.g., the format is CSV instead of JSON), the response optimization module 116 can cause the trained LLM 112 to generate a new response to the same prompt(s).

In another example, (superfluous) information that is included in a response generated by the trained LLM 112 and not directly responsive to the query of the prompt that caused the response to be generated, can be removed by the response optimization module 116, or the responsive information may be extracted from the superfluous information by the response optimization module 116. The response optimization module 116 may also be usable to perform other operations, such as ensuring that response information is properly input to a table or organized and saved in another manner, and/or that collected response information is uploaded to an appropriate file, etc. The computing system 102 may include or may be communicatively coupled to one or more database servers, network-attached storage units, and/or other storage devices, to store entity information generated by the trained LLM 112 in response to processing data instances. Storage devices usable herein may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory devices, or other suitable media.

As represented in FIG. 1, the computing system 102 may be communicatively coupled to one or more other computing systems. In this example, the computing system 102 more specifically is communicatively coupled to an entity monitoring computing system 118. In some examples, the entity monitoring computing system 118 may be a credit reporting computing system, such as a credit reporting computing system of a credit reporting agency such as Equifax®. In such an example, the entity monitoring computing system 118 may utilize entity information extracted from the one or more data sources 104 when scoring or reporting the creditworthiness or another characteristic of a given entity.

As also represented in FIG. 1, the entity monitoring computing system 118 can be communicatively coupled with one or more client computing systems 120. The client computing systems 120 may communicate with the entity monitoring computing system 118 over a network, which may be any type of network described above relative to the network 106 via which the computing system 102 communicates with the one or more data sources 104. The client computing systems 120 may include, for example, one or more computing devices such as individual servers or groups of servers operating in a distributed manner. For example, a client computing system 120 can include any computing device or group of computing devices operated by a client such as a seller of a product or service for which credit may be obtained, a lender, or any other client that requires credit worthiness or other information that is related to a given entity and possessed or accessible by the client computing system 120. The entity monitoring computing system 118 may, of course, be a different type of computing system associated with a different type of operator, in other examples. Also, while FIG. 1 illustrates that the computing system 102 and the entity monitoring computer system 120 are separate systems, it is possible in other examples for the computing system 102 and the entity monitoring computer system 120 to be one system. For example, the computing system 102 can be a part of the entity monitoring computer system 120, or vice versa.

The number of computing system 102 components illustrated in FIG. 1 is provided for illustrative purposes. Different numbers of components may be used in other examples. For example, while the components may be shown as single components in FIG. 1, the single components may be implemented as multiple components in other computing systems. Likewise, components that are shown to be separate in FIG. 1 may instead be implemented in a signal component.

FIG. 2 is a block diagram depicting the input to and output of a trained large language model (LLM) 200 used to identify an entity and verify entity attributes from a data instance of a data source according to some aspects of the present disclosure. As represented in FIG. 2, the trained LLM 200 can be provided with input data 202 comprising one or more data instances 204 in the form of writings such as news articles, editorials, exposés, or other textual publications from which information about an entity may be scraped. When the trained LLM 200 is a multimodal model, the data instances may additionally or instead include non-textual data, such as but not limited to images, videos, or audio files. In some examples, the model input 202 may include multiple data instances 204, and multithreading may be employed such that all of the data instances 204 can be processed simultaneously by the trained LLM 200.

As illustrated, the model input 202 in this example also includes an input prompt 206, which may be generated through use of the prompt engineering module 110 of FIG. 1. In some examples, the prompt 206 may be one of a pair (or more) of prompts that are provided to the trained LLM 200. The prompt 206 includes at least a query 208, instructions 210, and a deliberately false data item 212. The query 208 is the input portion 208 of the prompt 206 that is provided to the trained LLM 200 to obtain a result or prediction from the trained LLM 200. For example, in the context of identifying entities and/or verifying entity attributes within data instances, a query may take the form of a question such as “Did an acquisition occur?” The query 208 may also be more complex. For example, expanding on the above, another example of the query 208 may be “Did an acquisition occur, and if an acquisition occurred, when did it occur and who was the acquiring entity?”

The instructions 210, on the other hand, can explicitly direct the trained LLM 200 to generate a response of a particular type and/or format. For example, the instructions 210 may include directives such as “provide a yes or no answer only,” “provide the response in JSON format,” “if the information in the data instance is not in English, provide a summary of the information in English,” or “limit a summary of the information in the data instance to no more than 100 words.” Other types of instructions are, of course, also possible, including instructions on data that should be ignored, instructions that include the schema for a database from which a data instance is to be obtained, and so forth. The instruction examples provided herein are for purposes of illustration only, and are not intended to limit in any way the scope of instructions that can be included in a given prompt 206.

As described above, and as described in more detail below, the false data item 212 included in the prompt 206 allows for a response generated by the trained LLM 200 to be validated as not being affected by hallucinations. More specifically, based on the instructions 210 in the prompt 206, the false data item 212 (as processed by the trained LLM 200) is present in the output 214 of the trained LLM 200, along with a response 216 to the query 208, and can be used to determine that the response 216 is valid.

### Techniques for Identifying and Evaluating Entities Using a Trained LLM

FIG. 3 is a flow diagram 300 illustrating the use of an entity identification and attribute verification computing system (“computing system”) 302 to identify an entity and verify entity attributes from a data instance of one or more data sources 304 using a trained LLM 306 according to some aspects of the present disclosure. The computing system 302 may be the same as or similar to the computing system 102 of FIG. 1.

As indicated, a multithreading stage 308 receives a plurality of data instances from the one or more data sources 304 and subsequently inputs the plurality of data instances simultaneously to the trained LLM 306. The multithreading stage 308 may be omitted in other examples. However, as previously described, the use of multithreading can enable the trained LLM 306 to extract entity data from a data instance according to a query concurrently with processing an intentionally false data item. Multithreading can also allow the trained LLM 306 to parallel process multiple queries associated with different data instances and to generate multiple responses in parallel for different input prompts. Thus, while optional, use of the multithreading stage 308 offers many benefits, including a reduced response time when processing large volumes of data and the optimization of computing resources.

While LLMs typically excel at tasks such as natural language processing (NLP), including specific tasks such as named entity recognition (NER), entity extraction, sentiment analysis, etc., the use of LLMs is not without drawbacks. For example, due in part to the large size of their vocabularies, LLMs may suffer from hallucinations relating to the creation of content. The hallucinated content is neither correct nor factual but may appear to be believable within the context of the input. This can obviously be problematic, particularly when the content generated by an LLM is relied on for decision making, to configure another computer system or a computing device, or for any number of other purposes. When an LLM is known to suffer hallucinations, the content of the responses generated by the LLM must typically be checked by a human operator, which is labor intensive, prone to errors, and also highly inefficient.

Example systems and methods according to the present disclosure can overcome the problem of LLM hallucinations. For example, as shown in FIG. 3, use of the computing system 302 includes a prompting stage 310 where prompts are generated to cause the trained LLM 306 to output a desired response. In some examples, prompts may be generated at the prompting stage using a prompt engineering module such as the prompt engineering module 110 of FIG. 2. A prompt generated at the prompting stage 310 may include any of the content (e.g., queries, instructions) described above, and also includes the false data item described above with respect to FIGS. 1-2.

In this example, a first prompt 314 and a second prompt 316 are generated at the prompting stage 310. The first prompt 314 includes a query regarding possible entity information in the data instance, a false data item, and instructions that define a format for a response to the query and direct the trained LLM 306 to return the false data item with the response. The second prompt 316 includes the same query, the same false data item, and the same instructions as the first prompt 314.

As shown, the data instance(s) 312 and the first and second prompts 314, 316 are subsequently input to the trained LLM 306, which generates, within a response comparison and validation stage 318, a first response 320 to the query of the first prompt 314 and a second response 322 to the query of the second prompt 316. In addition to respective responses to the queries of the first and second prompts 314, 316, each of the first and second responses 320, 322 includes the false data item (as processed by the trained LLM 306).

The false data items in each of the first and second responses 320, 322 can be used to determine whether the first and second responses 320, 322 are valid or whether the trained LLM 306 suffered from a hallucination when generating one or both of the first and second responses 320, 322. While the trained LLM 306 may hallucinate while processing the data instance 312 in response to one or both of the first and second prompts 314, 316, it cannot hallucinate in the same manner, so the false data items cannot match when one or both of the first and second responses 320, 322 is a product of a model hallucination. Thus, the validity of the first and second responses 320, 322 can be determined by comparing the false data item in the first response 320 with the false data item in the second response 322.

More specifically, a response comparison stage 324 is included as part of the response comparison and validation stage 318. At the response comparison stage 324, it can be determined, by comparing the first response 320 to the second response 322, whether the false data item in the first response 320 matches the false data item in the second response 322. When the false data item in the first response 320 matches the false data item in the second response 322, one or both of the responses 320, 322 can be identified as valid responses.

As indicated in FIG. 3, when the false data item in the first response 320 does not match the false data item in the second response 322, the response comparison stage 324, the trained LLM 306 can be caused 326 to generate a new first response 320 to the query of the first prompt 314 and a new second response 322 to the query of the second prompt 316. It can then be determined, by comparing the new first response 320 to the new second response 322, whether the false data item in the new first response 320 matches the false data item in the new second response 322, and if so, one or both of the responses 320, 322 can be identified as valid responses. When the false data item in the new first response 320 still does not match the false data item in the new second response 322, the operations associated with generating and comparing new responses 320, 322 can be repeated. In some examples, the operations associated with generating and comparing new responses 320, 322 can be repeated until the false data item in a newest first response 320 matches the false data item in a newest second response 322, or until a predefined event transpires. In one example, the predefined event is repeating the operations of generating and comparing new responses 320, 322 a predetermined number of times. In another example, the predefined event is repeating the operations of generating and comparing new responses 320, 322 until the expiration of a predetermined time period.

Other handling and retry procedures may also be implemented. For example, as shown in FIG. 3, when the content of the first response 320 or the second response 322 received at the response comparison stage 324 is empty or invalid for other reasons, the content of the first response 320 and/or the second response 322 can be sent again, as indicated by the flow paths 328, 330. When the false data item in a newest first response 320 never matches the false data item in a newest second response 322 within an allowed number of attempts at generating and comparing new responses 320, 322 or within an allowable time period, the computing system 302 may move on from the data instance to a new data instance. In such a case, the data instance 312 for which no valid response was generated by the trained LLM 306 may be logged as part of an error logging process. In some examples, the data instance 312 may then be passed to a human operator for analysis.

A response 320, 322 that has been identified at the response comparison stage 324 may, in some examples, subsequently be directed to a response optimization stage 332. At the response optimization stage 332, a response 320, 322 that is valid in the context of model hallucinations, may nonetheless be rejected or optimized. For example, it is possible for the information presented in a response 320, 322 that is determined to be valid at the response comparison stage 324 to nonetheless be provided by the trained LLM 306 in a format that differs from the format of the information specified in the instructions of the prompt that caused the response to be generated. For example, the instructions of the prompt may specify that the content of an associated response is to be provided in JSON format, but the format of the information in a valid prompt 320, 322 is in CSV format. In such a case, the trained LLM 306 may be caused 334 to generate new first and second responses 320, 322 to the same first and second prompts 214, 316, and the new first and second responses 320, 322 may again be subjected to the response comparison stage 324 and to the response optimization stage 332 (when valid).

In another example, information that is included in a valid response 320, 322 generated by the trained LLM 306 but not directly responsive to the query of the associated prompt 314, 316, may be determined to be superfluous information and may be removed at the response optimization stage 332. Alternatively, the responsive information may be extracted from the superfluous information at the response optimization stage 332.

As further represented in FIG. 3, optimized response information, or response information that did not require optimization at the response optimization stage 332, may be directed downstream for further processing. For example, after the response optimization stage 332, response information can be input into a table as indicated at 336, or organized and saved in another manner. Collected response information, whether in table form or otherwise, may also be uploaded to a file 338 of desired format, which can then be stored, transferred to another system, or otherwise used in an entity-focused operation.

In this example, once a valid response has passed through the response optimization stage 332, the computing system 302 may output a command 340 to an entity monitoring computing system 342 to configure an assessment function of the entity monitoring computing system to utilize information about a given entity identified in the data instance 312 by the trained LLM 306 and included in the responses 320, 322. In some examples, configuring the entity monitoring computing system 342 may include sending the file 338 to the entity monitoring computing system 342. In any case, the entity monitoring computing system 342 can thereafter use the entity information generated by the trained LLM 306 from the data instance 312 when evaluating, analyzing, reporting, or performing other operations associated with the entity. For example, when the entity monitoring computing system 342 is a credit reporting computer system, the entity information may be used by the credit reporting computer system when calculating a credit/risk score (hereinafter “risk score”) or reporting a credit score or other related characteristics of the entity to a third party.

In a further example, information about a given entity that is extracted from a data source(s) by the trained LLM 306 and included in a response may be used by a credential controlled computing system to control access to certain operations or areas of the credential controlled computing system, or to services offered by an owner or operator of the credential controlled computing system. For example, when the information about a given entity is used by the entity monitoring computing system 342 to calculate a risk score for an entity, a third party credential controlled computing system may use the risk score to determine whether the entity can access certain areas of the credential controlled computing system or whether the entity is eligible for certain products or services offered by an owner or operator of the credential controlled computing system. In one particular example, the entity monitoring computing system 342 can be a credit reporting computing system, the credential controlled computing system can be a lender computing system, and the entity may be a borrower such as a corporate borrower. In this example, the lender computing system may obtain the calculated risk score for the borrower via communications with the credit reporting computing system and may subsequently use the risk score to control access of the borrower to the lender computing system. For example, the borrower may be denied access to areas of the lender computing system describing or offering products or services that require a higher (better) risk score than the risk score that was calculated for the borrower by the credit reporting computing system using information extracted from a data instance by the trained LLM 306 of the computing system 300.

In some other examples, a credential controlled computing system may receive or obtain information about a given entity that is extracted from a data source(s) by the trained LLM 306 directly from the computing system 300, rather than from an intermediary source such as the entity monitoring computing system 342. In this manner, the credential controlled computing system may calculate a risk score or make another entity assessment using the entity information and may thereafter use the risk score or other entity assessment to control access to certain operations or areas of the credential controlled computing system, or to services offered by an owner or operator of the credential controlled computing system.

In some examples, the information extracted from a data instance by the trained LLM 306 of the computing system 300 can be used to modify an entity assessment. For example, in the case of an entity risk score calculated using information about the entity extracted from a data instance by the trained LLM 306 of the computing system 300, the information may be used to modify an already existing risk score rather than to calculate a new risk score for the entity. This may be necessary or desirable for many reasons, such as for example, in a case where the entity acquires another entity or undertakes some other action that increases the financial risk associated with the entity as a borrower, business partner, etc. Thus, in the context of controlling access to a credential controlled computing system, entity information extracted from a data instance by the trained LLM 306 of the computing system 300 may be used to modify (e.g., increase or decrease) access of the entity to certain areas of the credential controlled computing system or to products or services offered by an owner or operator of the credential controlled computing system, such as due to a change in a calculated risk score of the entity.

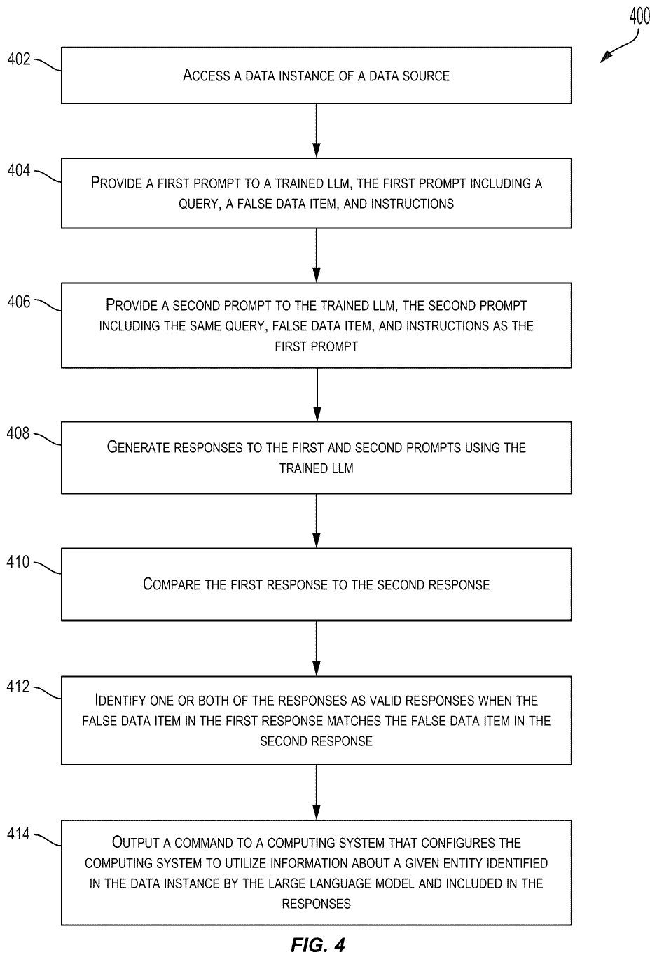

FIG. 4 is a flow chart illustrating a method for identifying an entity and verifying entity attributes from a data instance of a data source according to some aspects of the present disclosure. In some examples, the operations of the method 400, or any subset thereof, may be performed by the computing system 102, but other suitable systems, devices, or subsets or combinations thereof may perform one or more operations described with respect to the method 400. For illustrative purposes, the method 400 is described with reference to certain examples depicted in the figures. Other implementations, however, are possible.

At block 402, the method 400 involves accessing, by a processor, a data instance of a data source. In some examples, the data source may be a repository (e.g., an archive) of writings (i.e., data instances) such as news articles, editorials, exposés, or other publications from which information about an entity may be scraped. In other examples, a data source may be a repository of summaries of various pieces of writings prepared by a trusted source. A data instance may be, for example, a given writing of a plurality of writings in the repository. In certain examples, the data source may also or instead contain non-textual information (e.g., images, videos) and the data instance may be other than textual data.

At block 404, the method 400 involves providing, by the processor, a first prompt to a trained large language model, the first prompt including a query regarding possible entity information in the data instance, a false data item, and instructions that define a format for a response to the query and direct the trained large language model to return the false data item with the response. Similarly, at block 406, the method 400 involves providing, by the processor, a second prompt to the trained large language model, the second prompt including the same query, the same false data item, and the same instructions as the first prompt. The first prompt and the second prompt may be generated at a prompting stage of the method, such as through use of a prompt engineering module. In some examples, the trained large language model may be a multimodal model that can understand data in the form of images, videos, or audio, in addition to understanding text.

At block 408, the method 400 involves generating, using the trained large language model, a first response to the query of the first prompt and a second response to the query of the second prompt. In addition to information responsive to the query, each of the first response and the second response includes the false data item, as processed by the trained large language model.

At block 410, the method 400 involves determining, by the processor, by comparing the first response to the second response, that the false data item in the first response matches the false data item in the second response. At block 412, the method 400 involves identifying one or both of the responses as valid responses based on the matching of the false data items. When the false data items match, it can be ensured that the trained large language model did not hallucinate when generating the first and second responses, because the trained large language model cannot hallucinate in exactly the same manner when generating both responses, as would be required for the false data items to match across hallucinated responses.

Once the first and second responses are determined to be valid, the method 400 involves, at block 414, outputting by the processor, a command to an entity monitoring computing system that configures an assessment function of the entity monitoring computing system to utilize information about a given entity identified in the data instance by the large language model and included in the responses. In some examples, the entity monitoring computing system may be a credit reporting computer system of a credit reporting agency.

### Example of Computing System

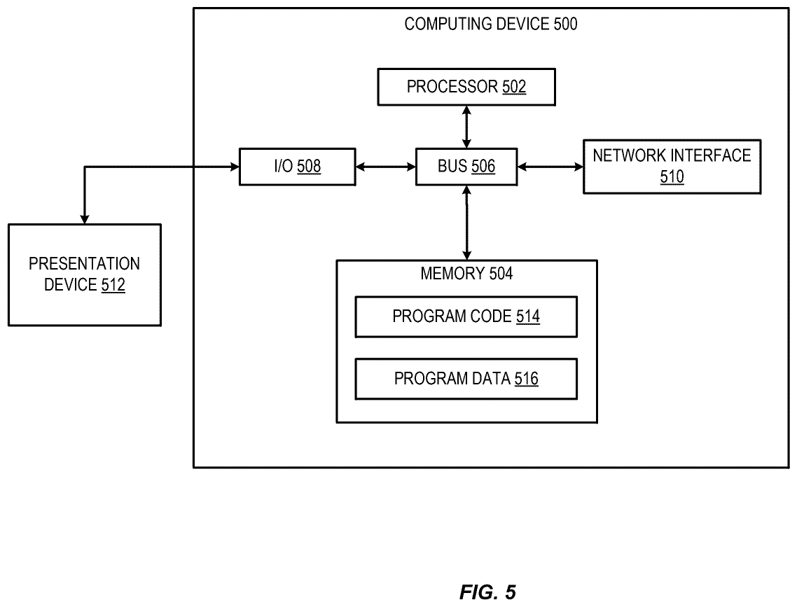

Any suitable computing system or group of computing systems can be used to perform the operations associated with the techniques described herein. Such a computing system may be or may include a computing device such as, for example, the computing device 500 depicted in the block diagram of FIG. 5. The computing device 500 can include various devices for communicating with other devices in the computing environment 100, as described with respect to FIG. 1. The computing device 500 can include various devices for performing one or more operations, such as entity identification and entity attribute verification operations, entity monitoring computing system configuration operations, or other operations described above with respect to FIGS. 1-4.

The computing device 500 can include a processor 502 that can be communicatively coupled to a memory 504. The processor 502 can execute computer-executable program code stored in the memory 504, can access information stored in the memory 504, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of the processor 502 can include a microprocessor, an application-specific integrated circuit (ASIC), a field-programmable gate array (FPGA), or any other suitable processing device. The processor 502 can include any suitable number of processing devices, including one. The processor 502 can include or communicate with a memory 504. The memory 504 can store program code that, when executed by the processor 502, causes the processor 502 to perform the operations described herein.

The memory 504 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Hadoop, C, C++, C#, Visual Basic, Java, Python, Perl, JavaScript, ActionScript, etc.

The computing device 500 may also include a number of external or internal devices such as input or output devices. For example, the computing device 500 is illustrated with an input/output interface 508 that can receive input from input devices or provide output to output devices. A bus 506 can also be included in the computing device 500. The bus 506 can communicatively couple one or more components of the computing device 500.

The computing device 500 can execute program code 514 that can include or may be associated with, for example, one of the modules depicted in FIG. 1. The program code 514 may be resident in any suitable computer-readable medium and may be executed on any suitable processing device. For example, and as illustrated in FIG. 5, the program code 514 can reside in the memory 504 at the computing device 500 along with the program data 516 associated with the program code 514. Executing an application or module of the computing system 102 or the computing system 302 can configure the processor 502 to perform at least a portion of the operations described herein.

In some aspects, the computing device 500 can include one or more output devices. One example of an output device can be or include the network interface device 510 illustrated in FIG. 5. A network interface device 510 can include any device or group of devices suitable for establishing a wired or wireless data connection to one or more data networks described herein. Non-limiting examples of the network interface device 510 can include an Ethernet network adapter, a modem, etc.

Another example of an output device can include the presentation device 512 depicted in FIG. 5. A presentation device 512 can include any device or group of devices suitable for providing visual, auditory, or other suitable sensory output. Non-limiting examples of the presentation device 512 can include a touchscreen, a monitor, a speaker, a separate mobile computing device, etc. In some aspects, the presentation device 512 can include a remote computing device that communicates with the computing device 500 using one or more data networks described herein. In other aspects, the presentation device 512 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A system comprising:
a processor; and
a non-transitory computer-readable medium comprising instructions that are executable by the processor for causing the processor to perform operations comprising:
accessing a data instance of a data source;
providing a first prompt to a trained large language model, the first prompt including a query regarding possible entity information in the data instance, a false data item, and instructions that define a format for a response to the query and direct the trained large language model to return the false data item with the response;
providing a second prompt to the trained large language model, the second prompt including the same query, the same false data item, and the same instructions as the first prompt;
generating, using the trained large language model, a first response to the query of the first prompt and a second response to the query of the second prompt;
determining, by comparing the first response to the second response, that the false data item in the first response matches the false data item in the second response;
based on the matching of the false data items, identifying one or both of the responses as valid responses; and
outputting a command to an entity monitoring computing system to configure an assessment function of the entity monitoring computing system to utilize information about a given entity identified in the data instance by the large language model and included in the first and second responses.

2. The system of claim 1, wherein the operations further comprise outputting the information about the given entity identified in the data instance by the large language model to a credential controlled computing system to control access to the credential controlled computing system by the entity.

3. The system of claim 1, further comprising a multithreader arranged to receive a plurality of data instances from the data source and to cause the plurality of data instances to be simultaneously processed by the large language model.

4. The system of claim 1, wherein the operations further comprise:
(a) accessing a second data instance of the data source;
(b) providing a new first prompt to the trained large language model, the new first prompt including a query regarding possible entity information in the second data instance, a false data item, and instructions that define a format for a response to the query and direct the trained large language model to return the false data item with the response;
(c) providing a new second prompt to the trained large language model, the new second prompt including the same query, the same false data item, and the same instructions as the new first prompt;
(d) generating, using the trained large language model, a new first response to the query of the new first prompt and a new second response to the query of the new second prompt;
(e) determining, by comparing the new first response to the new second response, whether the false data item in the new first response matches the false data item in the new second response;
(f) based on a determined mismatch between the false data items, identifying one or both of the responses as invalid responses; and
(g) repeating operations (d)-(e) until the false data item in a newest first response matches the false data item in a newest second response or until a predefined event transpires.

5. The system of claim 4, wherein the predefined event is selected from repeating operations (d)-(e) a predetermined number of times or an expiration of a predetermined time period.

6. The system of claim 1, wherein a response manipulation module is interposed between the large language model and the entity monitoring computing system and the operations further comprise:
receiving, by the response manipulation module, valid responses generated by the large language model; and
removing, by the response manipulation module, from the valid responses, superfluous information that is not directly responsive to the queries.

7. The system of claim 6, wherein for a given valid response that is not in the format defined by the instructions of the first prompt, the operations further comprise:
(a) causing the large language model to generate a new valid response by generating a new first response to the query of the first prompt and a new second response to the query of the second prompt;
(b) determining whether the new valid response is in the format defined by the instructions of the new first prompt; and
(c) based on determining that the new valid response is not in the format defined by the instructions of the new first prompt, repeating operations (a)-(b) until the new valid response is in the format defined by the instructions of the first prompt, until operations (a)-(b) are repeated a predetermined number of times, or until a predetermined time period expires.

8. A computer-implemented method comprising:
accessing, by a processor, a data instance of a data source;
providing, by the processor, a first prompt to a trained large language model, the first prompt including a query regarding possible entity information in the data instance, a false data item, and instructions that define a format for a response to the query and direct the trained large language model to return the false data item with the response;
providing, by the processor, a second prompt to the trained large language model, the second prompt including the same query, the same false data item, and the same instructions as the first prompt;
generating, using the trained large language model, a first response to the query of the first prompt and a second response to the query of the second prompt;
determining, by the processor, by comparing the first response to the second response, that the false data item in the first response matches the false data item in the second response;
based on the matching of the false data items, identifying one or both of the responses as valid responses; and
outputting, by the processor, a command to an entity monitoring computing system that configures an assessment function of the entity monitoring computing system to utilize information about a given entity identified in the data instance by the large language model and included in the responses.

9. The computer-implemented method of claim 8, further comprising outputting the information about the given entity identified in the data instance by the large language model to a credential controlled computing system to control access to the credential controlled computing system by the entity.

10. The computer-implemented method of claim 8, wherein a multithreader receives a plurality of data instances from the data source and causes the plurality of data instances to be simultaneously processed by the large language model.

11. The computer-implemented method of claim 8, further comprising:
(a) accessing a second data instance of the data source;
(b) providing a new first prompt to the trained large language model, the new first prompt including a query regarding possible entity information in the second data instance, a false data item, and instructions that define a format for a response to the query and direct the trained large language model to return the false data item with the response;
(c) providing a new second prompt to the trained large language model, the new second prompt including the same query, the same false data item, and the same instructions as the new first prompt;
(d) generating, using the trained large language model, a new first response to the query of the new first prompt and a new second response to the query of the new second prompt;
(e) determining, by comparing the new first response to the new second response, whether the false data item in the new first response matches the false data item in the new second response;
(f) based on a determined mismatch between the false data items, identifying one or both of the responses as invalid responses; and
(g) repeating operations (d)-(e) until the false data item in a newest first response matches the false data item in a newest second response or until a predefined event transpires.

12. The computer-implemented method of claim 11, wherein the predefined event is repeating operations (d)-(e) a predetermined number of times or an expiration of a predetermined time period.

13. The computer-implemented method of claim 8, wherein a response manipulation module is interposed between the large language model and the entity monitoring computing system, and the response manipulation module:
receives valid responses generated by the large language model; and
removes from the valid responses, superfluous information that is not directly responsive to the queries.

14. The computer-implemented method of claim 13, further comprising, for a given valid response that is not in the format defined by the instructions of the first prompt:
(a) causing the large language model to generate a new valid response by generating a new first response to the query of the first prompt and a new second response to the query of the second prompt;
(b) determining whether the new valid response is in the format defined by the instructions of the new first prompt; and
(c) based on determining that the new valid response is not in the format defined by the instructions of the new first prompt, repeating operations (a)-(b) until the new valid response is in the format defined by the instructions of the new first prompt, until operations (a)-(b) are repeated a predetermined number of times, or until a predetermined time period expires.

15. A non-transitory computer-readable medium comprising instructions that are executable by a processor for causing the processor to perform operations comprising:
accessing a data instance of a data source;
providing a first prompt to a trained large language model, the first prompt including a query regarding possible entity information in the data instance, a false data item, and instructions that define a format for a response to the query and direct the trained large language model to return the false data item with the response;
providing a second prompt to the trained large language model, the second prompt including the same query, the same false data item, and the same instructions as the first prompt;
generating, using the trained large language model, a first response to the query of the first prompt and a second response to the query of the second prompt;
determining, by comparing the first response to the second response, that the false data item in the first response matches the false data item in the second response;
based on the matching of the false data items, identifying one or both of the responses as valid responses; and
outputting a command to an entity monitoring computing system to configure an assessment function of the entity monitoring computing system to utilize information about a given entity identified in the data instance by the large language model and included in the responses.

16. The non-transitory computer-readable medium of claim 15, wherein the operations further comprise outputting the information about the given entity identified in the data instance by the large language model to a credential controlled computing system to control access to the credential controlled computing system by the entity.

17. The non-transitory computer-readable medium of claim 15, wherein a multithreader is arranged to receive a plurality of data instances from the data source and to cause the plurality of data instances to be simultaneously processed by the large language model.

18. The non-transitory computer-readable medium of claim 15, wherein the operations further comprise:
(a) accessing a second data instance of the data source;
(b) providing a new first prompt to the trained large language model, the new first prompt including a query regarding possible entity information in the second data instance, a false data item, and instructions that define a format for a response to the query and direct the trained large language model to return the false data item with the response;
(c) providing a new second prompt to the trained large language model, the new second prompt including the same query, the same false data item, and the same instructions as the new first prompt;
(d) generating, using the trained large language model, a new first response to the query of the new first prompt and a new second response to the query of the new second prompt;
(e) determining, by comparing the new first response to the new second response, whether the false data item in the new first response matches the false data item in the new second response;
(f) based on a determined mismatch between the false data items, identifying one or both of the responses as invalid responses; and
(g) repeating operations (d)-(e) until the false data item in a newest first response matches the false data item in a newest second response or until a predefined event transpires.

19. The non-transitory computer-readable medium of claim 15, wherein a response manipulation module is interposed between the large language model and the operations further comprise:
receiving, by the response manipulation module, valid responses generated by the large language model; and
removing, by the response manipulation module, from the valid responses, superfluous information that is not directly responsive to the queries.

20. The non-transitory computer-readable medium of claim 19, wherein for a given valid response that is not in the format defined by the instructions of the first prompt, the operations further comprise:
(a) causing the large language model to generate a new valid response by generating a new first response to the query of the first prompt and a new second response to the query of the second prompt;
(b) determining whether the new valid response is in the format defined by the instructions of the new first prompt; and
(c) based on determining that the new valid response is not in the format defined by the instructions of the new first prompt, repeating operations (a)-(b) until the new valid response is in the format defined by the instructions of the first prompt, until operations (a)-(b) are repeated a predetermined number of times, or until a predetermined time period expires.
